(19) United States
(12) Patent Application Publication
(10) Pub. No.: US 2017/0053008 A1
(43) Pub. Date: Feb. 23, 2017

(54) Time series explorer

(71) Applicant: Google Inc., Mountain View, CA (US)

(72) Inventors: Benjamin Frenkel, Santa Clara, CA (US); John Burge, Santa Clara, CA (US); Yi-Lun Ruan, Palo Alto, CA (US)

(21) Appl. No.: 15/240,719

(22) Filed: Aug. 18, 2016

Related U.S. Application Data
(60) Provisional application No. 62/206,729, filed on Aug. 18, 2015.

(51) Int. Cl. G06F 17/30

(52) U.S. Cl. CPC G06F 17/30572; G06F 17/30551; G06F 17/30554; G06F 17/30864; G06F 17/30601

(57) ABSTRACT

Systems and techniques are provided for a time series explorer. A request for time series including filter criteria may be received, a time series that is responsive to the request for time series may be determined by comparing event data for the time series stored in an event log to the filter criteria. The event data may include indications of an event that occurred in an application running on a computing device. A visual representation of the time series may be rendered. The visual representation of the time series may include a visual representation of an event indicated by the event data for the time series, and the visual representation of the time series may be transmitted to be displayed on a display.

### BACKGROUND

Developers of applications for computing devices may gather and use usage statistics to modify their applications to be more appealing to users. For example, developers of games for mobile devices may use statistics gathered from players of their games in order to modify and adjust their game, for example, to increase user engagement with the game. These statistics may be reported to developers in the aggregate, for example, using funnel diagrams. A funnel diagram may be used to represent players' experience of and responses to events in the game in the aggregate, for example, indicating the number of players that started a game, the number that reached a first level of the game, the number that reached a second level, and so on.

### BRIEF SUMMARY

According to an embodiment of the disclosed subject matter, a request for time series including filter criteria may be received, a time series that is responsive to the request for time series may be determined by comparing event data for the time series stored in an event log to the filter criteria. The event data may include indications of an event that occurred in an application running on a computing device. A visual representation of the time series may be rendered. The visual representation of the time series may include a visual representation of an event indicated by the event data for the time series, and the visual representation of the time series may be transmitted to be displayed on a display.

The event log may be received from a user computing device. The event log may be stored. To render the visual representation of the time series, a visual representation of the event may be rendered on a timeline, a visual representation of a second event indicated by the event data for the time series may be rendered on the timeline, and a visual representation of a third event indicated by the event data for the time series may rendered on the timeline. The visual representation of the event, the visual representation of the second event, and the visual representation of the third event may be rendered on the timeline to appear in chronological order.

A visual representation of a second time series may be rendered. The visual representation of the second time series may include a one visual representation of an event indicated by event data for the second time series. The visual representation of the second time series may be transmitted to be displayed on a display with the visual representation of the time series.

An indication of a selection of the visual representation of the event may be received through input to a user interface displayed on the display with the visual representation of the time series, a box including additional information associated with the event based on the event data from the event log may be rendered, and the box including the additional information may be transmitted to be displayed on the display.

Cluster analysis may be performed on time series stored in event logs. The cluster analysis may group the time series into clusters. Each cluster may correspond to a category. A group of time series in the middle of a first cluster of the clusters of time series may be determined for the first cluster of the clusters of time series. A time series that is a middle member of the group of time series in the middle of the first cluster may be determined.

A visual representation of the time series that is the middle member of the group of time series in the middle of the first cluster may be rendered, and the visual representation of the time series that is the middle member of the group of time series in the middle of the first cluster may transmitted to be displayed as a representative time series for a category associated with the first cluster.

According to an embodiment of the disclosed subject matter, a means for receiving a request for time series comprising a filter criteria, a means for determining a time series that is responsive to the request for time series by comparing event data for the time series stored in an event log to the filter criteria, the event data comprising indications of an one event that occurred in an application running on a computing device, a means for rendering a visual representation of the time series where the visual representation of the time series includes a visual representation of an event indicated by the event data for the time series, a means for transmitting the visual representation of the time series to be displayed on a display, a means for receiving the event log from a user computing device, a means for storing the event log, a means for rendering a visual representation of the event on a timeline, a means for rendering a visual representation of a second event indicated by the event data for the time series on the timeline, a means for rendering a visual representation of a third event indicated by the event data for the time series on the timeline, a means for rendering a visual representation of a second time series wherein the visual representation of the second time series includes a visual representation of an event indicated by event data for the second time series, a means for transmitting the visual representation of the second time series to be displayed on a display with the visual representation of the time series, a means for receiving an indication of a selection of the visual representation of the event through input to a user interface displayed on the display with the visual representation of the time series, a means for rendering a box comprising additional information associated with the event based on the event data from the event log, a means for transmitting the box comprising the additional information to be displayed on the display, a means for performing cluster analysis on time series stored in one or more event logs, where the cluster analysis groups the time series into two or more clusters, each cluster corresponding to a category, a means for determining, for a first cluster of the two more clusters of time series, a group of time series in the middle of the first cluster, a means for determining a time series that is a middle member of the group of time series in the middle of the first cluster, a means for rendering a visual representation of the time series that is the middle member of the group of time series in the middle of the first cluster, and a means for transmitting the visual representation of the time series that is the middle member of the group of time series in the middle of the first cluster to be displayed as a representative time series for a category associated with the first cluster, are included.

Systems and techniques disclosed herein may allow for a time series explorer. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for a time series explorer according to an implementation of the disclosed subject matter.

FIG. 2 shows an example arrangement suitable for a time series explorer according to an implementation of the disclosed subject matter.

FIG. 3 shows an example arrangement suitable for a time series explorer according to an implementation of the disclosed subject matter.

FIG. 4 shows an example arrangement suitable for a time series explorer according to an implementation of the disclosed subject matter.

FIG. 5 shows an example user interface suitable for a time series explorer according to an implementation of the disclosed subject matter.

FIG. 6 shows an example user interface suitable for a time series explorer according to an implementation of the disclosed subject matter.

FIG. 7 shows an example user interface suitable for a time series explorer according to an implementation of the disclosed subject matter.

FIG. 8 shows an example of a process suitable for a time series explorer according to an implementation of the disclosed subject matter

FIG. 9 shows a computer according to an embodiment of the disclosed subject matter.

FIG. 10 shows a network configuration according to an embodiment of the disclosed subject matter.

### DETAILED DESCRIPTION

A time series explorer may allow for the viewing of a sequence of events that occur for an individual, anonymized user of an application. The time series explorer may include data visualization techniques which may allow a developer to view events in the order in which those events occurred to a particular user of the developer's application. For example, a developer may use the time series explorer to view a series of events indicating that a particular player, whose identity may be anonymized, started playing the developer's game, spent $10, unlocked an in-game achievement, spent $5, stopped playing, and never returned to play the game again. The developer may use the time series explorer to view events for a number of users of the developer's application, for example, including individual, anonymized users, a sampling of users, or all users.

The events represented in a time series for a user may have been logged during the user's use of the application. For example, a game application may log an event when a player starts playing a game, when the player obtains achievements or items, reaches goals, levels, or checkpoints within the game, spends money within the game, stops playing, resumes playing, joins a multi-player tournament, wins or loses a multi-player match, achieves some number of wins in multi-player games, and/or stops playing and does not return to the game for a long enough period of time to infer the player does not intend to return to the game. The developer of an application may define events within the application in any suitable manner. For example, the developer may define any interaction they wish between the user and the application or any achievement or occurrence as an event that may be logged and later viewed using the time series explorer. An event may also involve no direct interaction between the user and the application. For example, a developer may define an event that occurs when the application has been running in the foreground of a user's computing device for a certain period of time independent of any user interaction with the application during that period of time. An event may also occur outside of the application, such as, for example, the user leaving a review of the application in an application store. Events may also be defined by, for example, a party responsible for the distribution of applications. This may allow for the definition of events on a level above the application level, so that different applications may make use of the same events, allowing for cross-comparisons of time series between applications from different developers who may otherwise define events their events differently.

Events may be logged by an application as the user uses the application, or as the application runs or events related to the application occur outside of the application, and stored as event data in event logs. The event logs may be stored locally, for example, on the user's computing device, and reported at intervals to a server accessible by the developer, for example, on a timed schedule, or when the user's computing device has internet access. In some implementations, the logs may be reported when the user's computing device has internet access through a WiFi network, and may not be reported when internet access is only available through a cellular network, so as to not use the user's cellular data allowance to report logged events. The event logs, including logged events, may be anonymized, so that an individual may not be identifiable from event logs from their use of an application. The event logs may include event data for any number of events, covering any suitable time period. For example, event logs may store event data for up to 120 days of events from an application. Event data for a logged event may include indicators of the user, anonymized so that events from the user may be collated but the individual user may not be identifiable, the application, the nature of the event, any metrics related to the event, such as an amount spent, time played, or score achieved, and a time at which the event occurred. Event data for events logged for a particular application for a particular user may form a time series for that user and that application. The event logs stored on a computing device may store event data for time series for different applications on the computing device, and for different users of the computing device. In some implementations, event data for time series for different users and application may be stored in separate event logs, and in some implementations event data for multiple time series may be stored in the same event log.

The time series explorer may be a tool on a computing device, such as a server, used by or accessible to a developer of applications for computing devices such as smartphones, tablets, wearable devices, laptops, and smart devices. The developer may use the time series explorer to view visual renderings of logged events from the use of the developer's application by various users. The visual rendering may include time series of events that were logged for users of the developer's application, rendered based on event data from event logs. The time series explorer may display separate time series for various users whose time series are selected for visual rendering. A visualization of a time series may include visual representations of events that occurred during a user's interaction with the application displayed in the order in which the events occurred. For example, the visualization of a time series may be displayed as a linear, horizontal timeline, with events represented by icons, symbols, graphics, or other visual representations on or in line with the timeline. The timeline may be displayed based on time, for example, starting at a time of 0, or an actual time, and increasing, or may be sequenced based, for example, where a time of 0 is set to coincide with the occurrence of a specific event, such as the first time a player spends money within a game, with events occurring before the time of 0 being associated with negative times and events after the time of 0 being associated with positive times, allowing for a before and after display of the time series of events. The visual representations for events may be spaced on the timeline based on the amount of time that elapsed between events. Visual representations for events along the timeline may include a vertical, or y-axis displacement, which may indicate a relative value or importance of the event as compared to other events in the time series. For example, an event in which a user spent money may be considered more important than an event in which the user obtained a free item, and thus the visual representation for the event where the user spent money may be located higher up from the timeline relative to the visual representation of the event where the user obtained the free item. Events in a time series may be represented on the timeline in any suitable manner, such a graphic, icon, or symbol. Different events may have different visual representations, and the representations may be varied for the same event. For example, a symbol representing a spending event may have its size change to reflect the amount of spent. The representations of events may also be color-coded, to further increase the visual distinction between events indicated on a timeline for a time series. For example, spending events may be color coded with a first color, achievement may be colored coded with a second color, and events where a user stopped using the application may be color coded with a third color.

The time series explorer may allow for user segmentation based on any suitable criteria. For example, users may be segmented based on how much they spend, how engaged they are with the application, or how fast they progress using the application, for example, how fast they progress through levels in a game or obtain achievements in the game, what rating they gave to the application, and so on. User segmentations may allow for the display of visual representations of time series from users from different segments, for example, to allow for visual analysis and comparison of the time series.

The time series explorer may allow for visualizations of time series from any number of users of an application to be viewed at the same time. For example, a developer may select a specific segment or segments of users and view time series from users within that segment. The time series explorer may allow for panning and zooming, so that visualizations for individual time series, and segments thereof, may be viewed up close and scrolled through, and so that an entirety of user segments may be viewed at once given a high enough screen resolution. The developer may select which events may be displayed in the time series of events they are viewing, and may select how may time series are shown at once. Statistics related to a selected time series, or a group of selected time series, may be displayed in any suitable manner. For example, a developer using the time series explorer may hover their cursor over a row header for a visualization of an individual time series to pop-up a box including statistics for that time series, such as, for example, total amount spent by the user represented by the time series, total time spent engaged with the application, number of discrete use sessions, and so on. The time series explorer may allow for the filtering of displayed time series. For example, a developer may filter the time series shown in the time series explorer based on the amount spent, the time at which the user started using the application, and the time at which the user appears to have stopped using the application with no intent to return to it, time between starting and stopping of the use of the application, achievements gained or progress made, items obtained, and any other suitable criteria. This may allow a developer to view, for example, a comparison of time series from users in the same cohort based on the date on which they started using the application. The developer may choose which events are shown in the visualization of a time series and which are not. The developer may use the time series explorer to compare time series of different cohorts of users based on their start date of use of the application, for example, comparing all of the users who started using the application on a particular day or during a particular week.

The time series explorer may display statistics and data based on analytics performed on time series in any suitable manner. For example, Markov chain based data may be displayed by the time series explorer. The developer may be able to filter the time series displayed based on edge strength as determined based on Markov chain output.

After selecting a segment of users for which to view time series, the developer may select the basis of the x-axis, for example, as either time, or as a sequence based on the occurrence of a specific event. When the developer selects to show the x-axis on the basis of time, the time series explorer may then prompt the developer to select the length of time to view. For example, the developer may select to view events in the time series over 28 days. The time series explorer may display graphs or other data representations in addition to the visualization of the time series. The graphs may include summary data related to the displayed time series, such as, for example, the length of a time from when a user starts using an application to when the first money is spent by the user within the application, the rate of progress per day a user makes in the application, and how many sessions the user engages during some time period of use of the application. The graphs may be, for example, bar graphs, with each bar representing a single user whose time series is also displayed.

While a visualization for a time series is displayed, individual events may be selected from the time series in any suitable manner so that more information about the selected event may be viewed. For example, the developer may hover their cursor over the displayed representation, for example, icon, symbol, or graphic, of an event in a time series, to cause the display of additional information about that event by the time series explorer. The additional information may include, for example, a full description of the event, a time, day, and date for the event, and aggregate data related to the event. For example, if a user purchases a specific item, the additional information for that event in the time series may include the date on which the user made the purchase, how much money the user spent, the quantity and identity of the item the user purchased, aggregate totals of how many of that item have been sold over the lifetime of the application and how much revenue that item has generated. If the user gained some achievement, the additional information displayed on selection of the representation of that event may include the name of the achievement, a graphic associated with the achievement, the data on which the achievement was obtained, and any other useful data related to achievements.

At some levels of zoom, events in a time series may be compressed on the displayed timeline for the time series so that they overlap. A different visual representation may be used to indicate points on the timeline where multiple events overlap at the current zoom level, so that the developer may view all of the overlapping events individually, for example, by selecting an icon used to represent overlapped events, or by zooming in further. For example, hovering a cursor over an icon or symbol representing overlapping events may pop-up additional information for all of the overlapping events. The developer may then zoom-in on the overlapped events to separate the events out with separate visual representations or indications on the timeline for each event.

The time series explorer may include a number of pre-set views. The pre-set views may be selected directly by a developer using the time series explorer, or may be selected by the time series explorer based on a question entered into the time series explorer by the developer, such as, for example, “What happens at the start of gameplay?”, “What happens before the user first spends money?”, and “What happens before the user quits using the application?”. The pre-set views may highlight events or series of events that may be considered critical in the relationship between the user and the application, such as events that occur in the first few minutes of use of the application, events that occur before the user spends money, and events before the user gives a good or bad review to the application, events before the application crashes, and events that occur before the user quits the application without intent to return to it.

For example, a pre-set view for the first few hours of application use may include segments of users who have demonstrated different levels of spending over their lifetime of use of the application, for example, a segment with users who have spent a lot of money, a segment of users who have spent some money, and a segment of users who have spent no money. The visualizations for the time series for each user may be ordered by time, with visual representations of events arranged chronologically on a timeline based on the time stamps indicating when the events occurred. The time series may cover a time period of, for example, one to two hours, starting with the user's first use of the application. Only users who used the application for 28 days, for example, did not quit without intent to return before 28 days, may be displayed. This may allow a developer to view events that occurred in the first one to two hours of application use for new users, and to compare those events across different segments of spending, to determine if any events in the first one to two hours of use appear correlated with a user spending more money on the application. For example, if a particular event in the first two hours of use correlates strongly with users who end up spending more money over the lifetime of their use of the application, the developer may modify the application so that more users may experience that event within their first one to two hours of use.

Another pre-set view may focus on users who end up spending money within an application, and what events may precede and/or follow their first spending of money. The time series explorer may show segments with visualizations of time series of users who have demonstrated different levels of spending over their lifetime of use of the application, for example, a segment with users who have spent a lot of money, a segment of users who have spent some money, and a segment of users who have spent no money. The visualizations of time series may be organized by sequence, indexed from a user's first spending event. Time before the first spending event may be indicated on the timeline with negative numbers, and time after the first spending event may be indicated on the timeline with positive numbers. The developer may be able to examine the time series and observe what events appear to precipitate the first spending event, and what events follow.

Another pre-set view may be used to determine why players quit the application without intent to return. The time series explorer may show visualizations of time series from a segment of users who have all quit using the application and have not returned for some specified time period, indicating that the user has churned, or has no intent to the use application again. The visualizations of time series for each user may be displayed on a timeline with the churn event, where the user last quit the application and has since not returned, is indexed at time zero. The developer may then view the events that lead to the churn event for each user, and may filter the time series based on how long the churn event took from when the user first started using the application. This may allow a developer to identify events or conditions, for example, slow frame rates in a game, which may result in a user quitting their application, and to modify the application to prevent the events from occurring.

The time series explorer may allow for views of aggregate data based on events. For example, a developer may view a graph where lines on the graph each represent a specific event, with the x-axis representing time, for example, dates, and the y-axis representing the aggregate occurrence of that even among all users or a segment of users of the developer's application. This may allow, for example, the user to view a graph showing the relative frequency with which different types of user spending or engagement events occurred within a segment of users over a time period, such as a month. Aggregate data may include the total value of an event, for example, in currency or progress, the average value of an event per user that experienced the event, the cumulative value of an event, the number of events, the number of events per user, for example, on a per day basis, the number of unique active users that triggered an event, and aggregate data for cohorts of new users, including cumulative value of events, cumulative count of unique events over time, and cumulative percentage of users from the new user cohort who triggered the event over time.

Machine learning systems may be used to make predictions about users of an application based on events logged for that user. For example, a machine learning system may be trained on events from users who have, for example, spent a certain amount on a game. The machine learning system may then be used to classify users of the game who have not yet spent that amount based on whether they are predicted to eventually spend that amount, based on logged events for those users. Predictions made by a machine learning system may be considered an event. When a machine learning system makes a prediction for a user, for example, predicting that they will spend a certain amount in a game, the prediction may be added to the events that have been logged for that user for that game, and may appear as an event, with a visual representation, in time series displayed for that user. This may, for example, allow for visual determination of whether a prediction is accurate, as a developer may view a time series with a prediction and determine if events that occur subsequent to the prediction confirm the prediction.

Cluster analysis may be used on time series from various users to determine time series that may be representative of different user types for a particular application. For example, cluster analysis may be used to group time series from various users into certain categories based on similarity between the time series. A group of time series that represent the middle of a cluster for a particular category may be determined, and the middle member of the that group may be used as a representative time series for that category. Categories may be, for example “quick churner”, which may include time series that indicate users who churned quickly in a game, “rapid progressor”, which may include time series that indicate users who made rapid progress through a game, “slow progressor”, which may include time series that indicate users who made slow progress through a game, “slow spender’, “quick spender”, “non-spender”, “spender” and “engaged non-spender”, which may include time series that indicates users who demonstrate different levels of spending while using a game. Cluster analysis may, for example, determine a time series that may be most representative of all users who can be classified as “quick churners”. This representative time series may, for example, include a limited number of events occurring in a short time frame followed by a churn event.

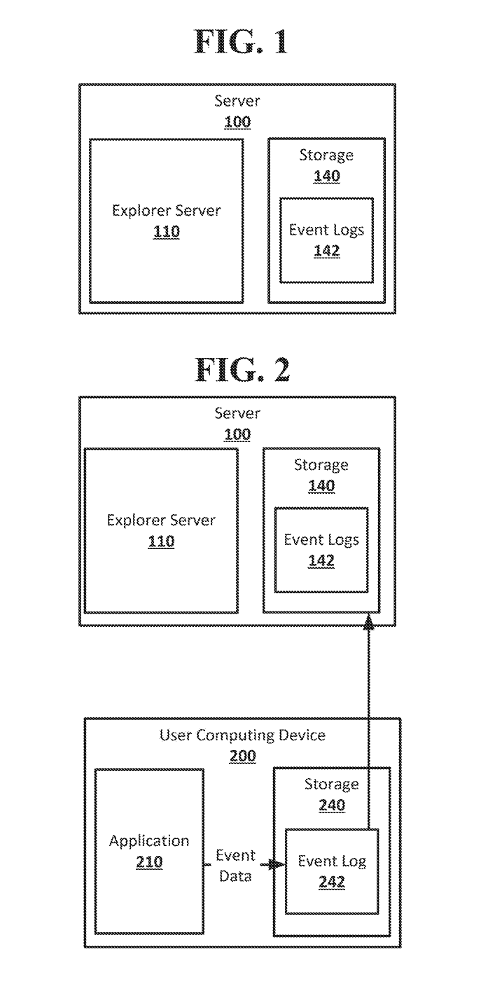

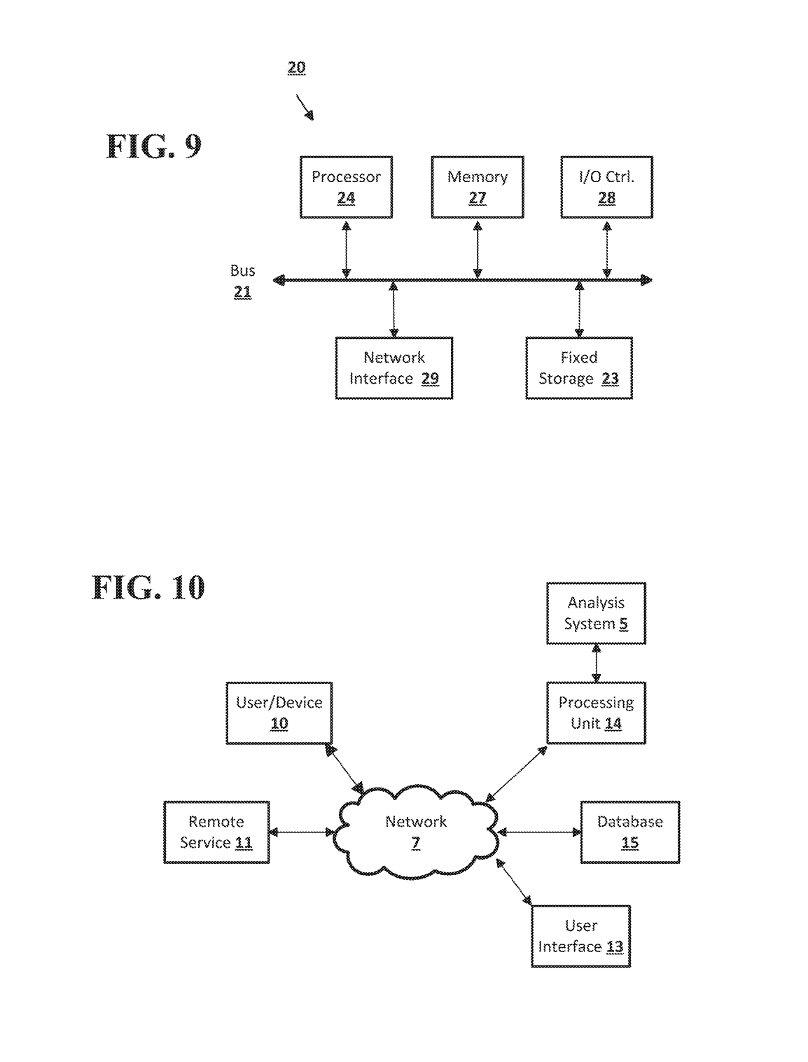

FIG. 1 shows an example system suitable for a time series explorer according to an implementation of the disclosed subject matter. A server 100 may include an explorer server 110 and storage 140. The server 100 may be any suitable device, such as, for example, a computer 20 as described in FIG. 9, for implementing the explorer server 110 and the storage 140. The server 100 may be a single computing device, or may include multiple connected computing devices, and may be, for example, a server computer that is part of a server farm. The storage 140 may store event logs 142. The event logs 142 may store event data. The event data may be data about events gathered based on the use of an application or applications by any number of users, and based on the running of the application or applications or events outside of the application or applications that pertain to the application or applications. The event data may form time series. For example, event data logged from a particular users use of a particular application, along with other events that occurred pertaining to that application on that users computing device, may form a time series for that user and that application. The event logs 142 may include event data for any number of time series, for any number of users and any number of applications. For example, the event logs 142 may, for example, include event data that form time series for all of the users of a particular developer's applications. The storage 140 may store the event logs 142 in any suitable format.

The explorer server 110 may be any suitable combination of hardware and software on the server 100 which may analyze event data and render for display visualizations of time series based on the event data from the event logs. The explorer server 110 may be a tool, for example, part of a time series explorer, which may be accessible to a developer's computing devices, for example, through an application or web browser, and may allow a user of the developer's computing device to view visualizations of time series based on event data generating from the logging of events from the developer's applications and stored in the event logs 142. For example, the explorer server 110 may generate visualizations of time series, which may be graphical representations of event data from the event logs 142, by representing events indicated by the event data with any suitable visual representations, such as suitable combinations of shapes and colors, arranged on a linear timeline which may be displayed on a display connected to the developer's computing device. The visual representations may represent events that occurred during a user's interaction with an application whose event logs are stored in the event logs 142. The events may be, for example, when a user starts playing a game or using an application, when the user obtains achievements or items, reaches goals, levels, or checkpoints within the game, spends money within the game, stops playing, resumes playing, joins a multi-user tournament, wins or loses a multi-user match, achieves some number of wins in multi-user games, when the game or application crashes, when a frame rate of the game or application drops below some threshold value, when the user leaves a review of the game or application, when a game or application has been running in the foreground of the user's computing device for some specified period of time even without interaction from the user, and/or stops playing the game or using the application and does not return to the game or application for a long enough period of time to infer the user does not intend to return to the game or application.

The explorer server 110 may allow for user segmentation based on any suitable criteria. For example, users of an application with event data stored in the event logs 142 may be segmented based on how much money the users spend while using the application, how engaged the users are with the application, or how fast a user progresses using the application, for example, how fast they progress through levels in a game or obtain achievements in the game, what rating the users gave to the application, or based on any other suitable criteria that may allow for segmentation of the users of an application based on the event data in the event logs 142. The explorer server 110 may allow for visualizations of time series from any number of users of an application to be viewed at the same time. For example, the explorer server 110 may be used to render time series for specified segment or segments of users. The explorer server 110 may allow for panning and zooming through displayed time series, for example, using the display and controls of a developer's computing device. The events displayed in the visualization of the time series may be selected, for example, through user interface of the explorer server 110 which may be displayed by and interacted with through the developer's computing device. Statistics related to a selected time series, or a group of selected time series, may be displayed in any suitable manner. The explorer server 110 may allow for statistics and data based on analytics performed on time series in any suitable manner to be displayed. For example, Markov chain based data may be displayed by the time series explorer. The developer may be able to filter the time series displayed based on edge strength as determined based on Markov chain output.

FIG. 2 shows an example arrangement suitable for a time series explorer according to an implementation of the disclosed subject matter. A user computing device 200 may include an application 210 and a storage 240. The user computing device 200 may be any suitable device, such as, for example, a computer 20 as described in FIG. 9, for implementing the application 210 and the storage 240. The user computing device 200 may be a single computing device, or may include multiple connected computing devices, and may be, for example, a smartphone or tablet using a mobile platform that includes a mobile operating system. The application 210 may be any suitable application which may be installed and run on the user computing device 200. For example, the application 210 may be a game, productivity application, information-providing application, social media application, entertainment or media application, or any other application type. The application 210 may be installed on the user computing device 200 in any suitable manner. For example, the application 210 may be downloaded and installed directly from a developer of the application, or from an application store that may be associated with a mobile platform used by the user computing device 200. The storage 240 may store an event log 242. The storage 240 may store the event log 242 in any suitable format.

The event log 242 may store event data generated based on the running of the application 210 on the user computing device 200. For example, as a user interacts with the application 210 on the user computing device 200, data indicating events that occur during the interaction may be logged to the event log 242. Event data may also be generated while the application 210 is running, even when the user is not actively using or interacting with the application 210. The event data stored in the event log 242 may indicate the occurrence of any suitable events, which may be defined by, for example, the developer of the application 210, or by, for example a party responsible for distributing the application 210, for example, through an application store. The events may be, for example, when a user starts using the application 210, for example, starts playing a game, obtains achievements or items, reaches goals, levels, or checkpoints within the application 210, spends money within the application 210, stops playing, resumes playing, joins a multi-user tournament, wins or loses a multi-user match, achieves some number of wins in multi-user games, when the application 210 crashes, when a frame rate of the application 210 drops below some threshold value, when the user leaves a review of the application 210, when the application 210 has been running in the foreground of the user computing device 200 for some specified period of time even without interaction from the user, and/or when the user stops using the application 210 and does not return to application 210 for a long enough period of time to infer the user does not intend to return to the application 210. The event data for an event logged to the event log 242 may include, for example, indicators of the user, anonymized so that event data from the user may be collated but the individual may not be identifiable, the application, the nature of the event, any metrics related to the event, such as an amount spent, time played, or score achieved, frame rate, crash type, and a time at which the event occurred. The event log 242 may store any suitable number of events for the application 210, covering any suitable time period. The event data stored in the event log 242 based on events that occur in the application 210 may form a time series for the user of the user computing device 200 and the application 210.

The event log 242 may be transmitted to the server 100. The event log 242 may be transmitted from the user computing device 200 using any suitable communications hardware and software, such as, for example, WiFi or cellular communications hardware and protocols. The event log 242 may be transmitted to the server 100 at any suitable time, such as, for example, on a timed schedule, or when the user computing device 200 has internet, or when the user computing device 200 has internet access through a WiFi network. The server 100 may receive the event log 242 from the user computing device 200, and may store the event log 242. For example, the event log 242 may be stored in the storage 140 with the event logs 142.

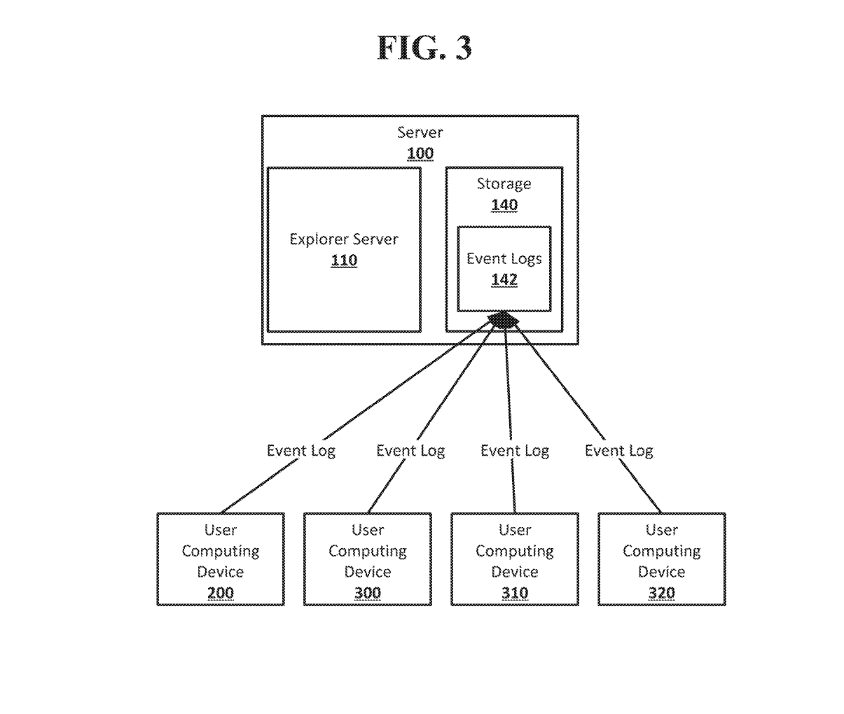

FIG. 3 shows an example arrangement suitable for a time series explorer according to an implementation of the disclosed subject matter. The server 100 may receive event logs, such as the event log 242, from multiple user computing devices, such as, the user computing devices 200, 300, 310, and 320. For example, the application 210 may be installed and run on each of the user computing devices 200, 300, 310, and 320, resulting in an event log, such as the event log 242, being stored on the user computing devices 200, 300, 310, and 320. The server 100 may receive these event logs and store them with the event logs 142 in the storage 140. The server 200 may also receive event logs for applications other than the application 210 that may be installed and run on the computing devices 200, 300, 310, and 320. The received event logs may include event data for time series for each of the users of the application. For example, an event log received from the user computing device 300 based on events logged from the application 210 running on the user computing device 300 may include event data for a time series based on use of the application 210 by the user of the user computing device 300.

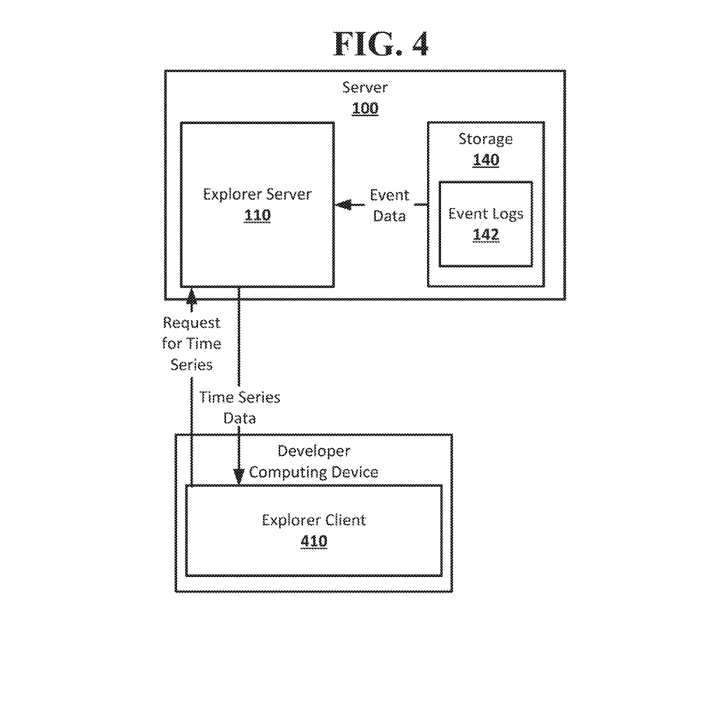

FIG. 4 shows an example arrangement suitable for a time series explorer according to an implementation of the disclosed subject matter. A developer computing device 400 may include an explorer client 410. The developer computing device 400 may be any suitable device, such as, for example, a computer 20 as described in FIG. 9, for implementing the explorer client 410. The developer computing device 400 may be a single computing device, or may include multiple connected computing devices, and may be, for example, a desktop, laptop, or other personal computer running any suitable operating system, or a smartphone or tablet using a mobile platform that includes a mobile operating system. The developer computing device 400 may be a computing device used by a developer of applications, such as, for example, the application 210. The explorer client 410 may be any suitable combination of hardware and software that may be used to view and interact with time series data provided by the explorer server 110. For example, the explorer client 410 may be a specialized application for viewing and interacting with time series data installed and run on the developer computing device, or may be a general purpose application, such as, for example, a web browser which may be used to access a web site that may be part of, or operated in conjunction with, the explorer server 110 on the server 100, which may operate as a web host.

A request for time series may be transmitted to the server 100 from the developer computing device 400. For example, the explorer client 410 may display, on a display connected to the developer computing device 400, a user interface which may be used to request time series from the explorer server 110. The user interface may be, for example, a specialized application interface, or may be, for example, displayed as a web page in web browser. The explorer client 410 and the explorer server 110 may communicate using any suitable communications protocol, and may use any suitable communications hardware and software of the developer computing device 400 and the server 100. The time series may be requested in any suitable manner. For example, the time series may be requested for a specific application, for example, the application 210 which may have been created by the user of the developer computing device 400. The time series may be requested for a specific, anonymized user of the application, for example, selected from a list of anonymized users, for a random anonymized user, or for an anonymized user or users whose event data matches certain criteria, such as, for example, users who used the application 210 within the last two weeks.

The explorer server 110 may provide time series data to the explorer client 410 based on the request for time series and event data from the event logs 142, gathered from various users of the application, such as the application 210, in the storage 140. The time series data may be all of the event data for time series form the event logs 142 that are responsive to the request for time series. The explorer server 110 may transmit the time series data in any suitable format. For example, the explorer server 110 may render visualizations of the time series from the time series data and send the rendered visualizations of the time series to be displayed by the explorer client 410. The explorer server 110 may also transmit the time series data without rendering visualizations of the time series. This may result in the explorer client 410 receiving the event data that would be used to render visualizations of the time series that were responsive to the request for time series. The explorer client 410 may then render visualizations of the time series from the for display based on the received time series data. The visualizations of the time series may be rendered as, for example, a horizontally displayed timeline on which are arranged visual representations of the events based on the event data in the time series data. The visual representations may be arranged on the timeline in chronological order.

The user interface of the explorer client 410 may be used to interact with the displayed time series. For example, a user may select the visual representation of an event on a time series timeline to display further information about the event, for example, based on the event data that was logged when the event occurred. For example, the explorer client 410 may display a full description of the event, an icon or image representing the event, a time, day, and date for the event, and aggregate data related to the event. The user interface of the explorer client 410 may be used to zoom in and out on the displayed time series, for example, displaying the time series over shorter or longer time periods. The user interface of the explorer client 410 may be used to filter which events have visual representations displayed on the time series timelines.

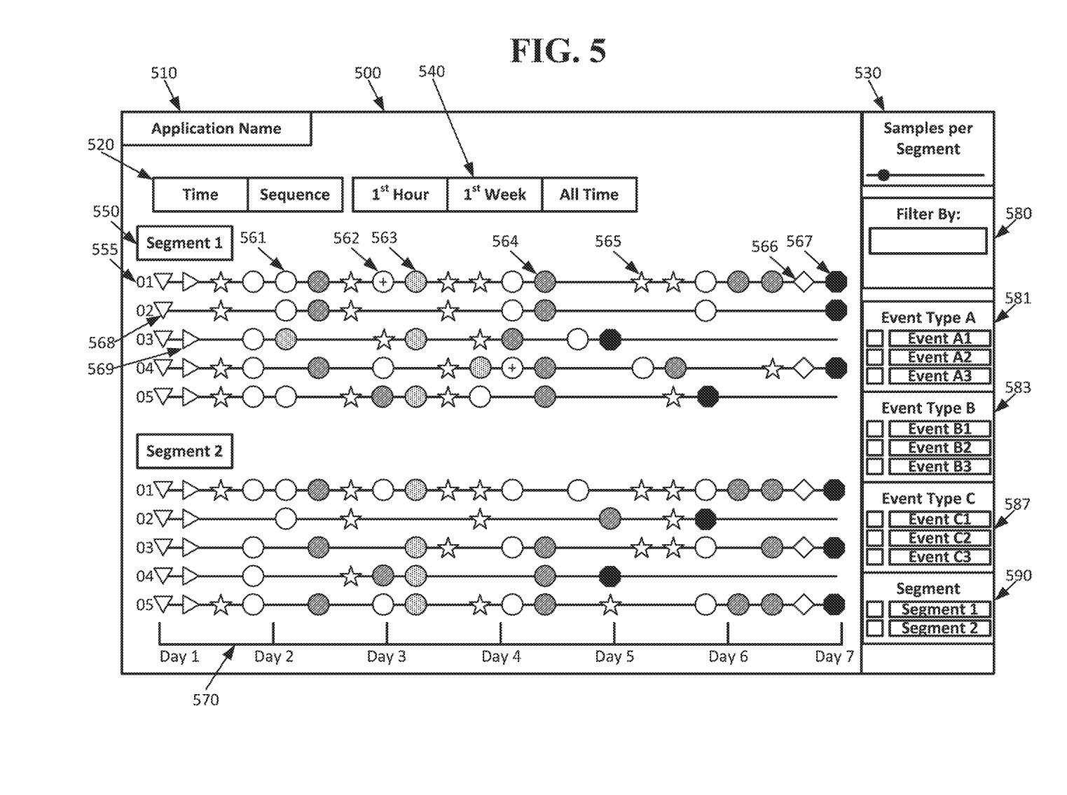

FIG. 5 shows an example user interface suitable for a time series explorer according to an implementation of the disclosed subject matter. A user of the explorer client 410 may interact with the explorer server 110 and time series displayed based on event data through a user interface 500. The user interface 500 may display any suitable user interface elements. For example, an application name 510 may be displayed. The application name 510 may be the name or other identifier for an application, such as the application 210, from the event data used in the visualizations of time series displayed in the user interface 500 was logged. In some implementations, the user interface 500 may display time series using event data from more than one application, and the application name 510 may be used to display names or identifiers for all applications with event data displayed in a time series. A timeline control 520 may be used to determine how the visual representations of events are organized on a timeline for a visualization of a time series displayed in the user interface 500. For example, the visualization of the time series may be organized by time, so that the distance on the timeline between visual representations may be proportional to an actual amount of time that elapsed between the occurrences of the represented events. Events which occurred father apart, as indicated by their event data, may have their visual representations father apart on the timeline. The visualization of the time series may be organized by sequence, so that the distance on the timeline between visual representations may be the same regardless of the actual amount of time that elapsed between the occurrences of the represented events. A samples control 530 may be used to control how many time series are displayed for each displayed segment. For example, if the samples control 530 is set to “5”, visualizations for five separate time series may be displayed for each displayed segment. The time series may be from the same or different users, and may be selected from the event data in any suitable manner. A date window control 540 may be used to determine the size of the date window for which event data will be displayed in the user interface 500. The date window control 540 may allow for the selection of any suitable date window, with any suitable level of granularity, in any suitable manner. For example, the date window control 540 may include a series of selectable buttons which may be used to select a date window of 1^{st} hour, 1^{st} week, and All Time.

The visualizations of time series displayed in the user interface 500 of the explorer client 410 may be organized by segment. The time series explorer may allow for time series from any number of users to be viewed at the same time. For example, a developer may select a specific segment or segments of users and view time series for users from within that segment. The user interface 500 may allow for panning and zooming, so that the visualizations of individual time series may be viewed up close and scrolled through, and so that all of the visualizations of time series for a number of user segments may be viewed at once given a high enough screen resolution. A segment indicator 550 may indicate which segment the time series whose visualization is displayed near the segment indicator 550 belong to. Different segments may represent, for example, users of an application, such as the application 210, who have demonstrated different levels of spending over their lifetime of use of the application, or any other suitable group into which users of an application may be segmented based on the event data for those users' time series. The user interface 500 may display any suitable number of different segments at the same time, and each displayed segment may have an associated segment indicator such as the segment indicator 550.

A time series visualization 555 may be displayed in the user interface 500 using any suitable number of visual representations for event data organized in chronological order on a timeline. The visual representations may be, for example, a graphic, icon, or symbol, such as, for example, the symbols 561, 562, 563, 564, 565, 566, 567, 568, and 569. The visual representations of events may be color-coded, shape-coded, and may include superimposed symbols, which may increase the visual distinction between events indicated on a timeline for the time series visualization 555. For example, the symbol 561 may be a circle having a first color and may represent, for example, a level-clearing event in a game. The symbol 562 may be a circle having a first color and including superimposed “+” symbol and may represent multiple events that occurred at the same time and may be viewed individually by selected the symbol 562. The symbol 563 may be circle having a second color and may, for example, represent a spending event. The symbol 564 may be a circle having a third color and may, for example, represent a player failure event within a game. The symbol 565 may be a star and may, for example, represent an achievement event within a game. The symbol 566 may be a diamond and may, for example, represent user retention milestone event. The symbol 567 may be an octagon having a fourth color and may, for example, represent a churn event. The symbol 568 may be a downward pointing triangle, and may, for example, represent a session start event. The symbol 569 may be a sideways pointing triangle and may, for example, represent a start playing event in a game. Any other suitable visual representation, having any suitable color and shape, or being a character, icon, or other graphical depiction, may be used to represent any suitable event. The visual representations may be varied for the same event. For example, a symbol representing a spending event may have its size changed to reflect the amount spent, with a larger symbol used to represent a larger amount spent. The symbols representing events may be spaced on the timeline for the time series visualization 555 based on the amount of time that elapsed between events. Symbols representing events along the timeline may include a vertical, or y-axis displacement, which may indicate a relative value or importance of the event as compared to other events in the time series visualization 555.

A time key 570 may be displayed in the user interface 500 in any suitable manner, and at any suitable location, and may provide a key to measuring the time elapsed along the timelines displayed for the time series such as the time series visualization 555. The display of symbols in a time series may be arranged along the timelines so that the relative time at which an event occurred, as represented by a symbol, can be determine with reference to the time key 570. The time key 570 may provide a reference time in any suitable manner. For example, the time key 570 may indicate the passage of days, starting at a Day 1, with the same distance on the display being used to represent the amount of time in each day. The time key 570 may change when a user zooms in or out, or pans, on the displayed time series in the user interface 500, in order to reflect the time period during which the events displayed with visual representations on the timelines occurred.

Time series filter 580 may allow for the filtering of the time series displayed in the user interface 500. A user may, for example, click on the time series filter 580 to pop up a menu of events and other filter criteria which the user may use to filter the time series. For example, a developer may filter the time series shown based on the amount a user spent in an application, the time at which the user started using the application, and the time at which the user appears to have stopped using the application with no intent to return to it, time between starting and stopping of the use of the application, achievements gained or progress made, items obtained, predicted future spending of the user in the application or other predicted future uses of the application by the user, or any other suitable filter criteria. This may allow a developer to view, for example, a comparison of time series from users in the same cohort based on the date on which they started using the application. When the time series filter 580 is used to select filter criteria, the filter criteria may be transmitted to the explorer server 110, which may use the filter criteria to filter the event data in the event logs 142 and provide the viewer 110 with appropriate time series data for display, or may be used directly by the explorer client 410 to determine appropriate time series to display based on time series data already received from the explorer server 110. The time series filter 580 may be used to determine the users whose time series are displayed in the segments in the user interface 500. For example, the time series filter 580 may be used to establish a first set of filter criteria, which may determine which time series are displayed in a first segment, and then may be used to established a second set of filter criteria, which may determine which time series are displayed in the second segment. For example, the first segment may display time series from users whose event data includes a churn event that occurred with seven days of their first use of an application, and the second segment may display time series form users whose event does not include a churn event within seven days of their first use of the same application.

Filtering time series based on predictions of future behavior may be based on, for example, analysis and classification of time series by machine learning systems. For example, a machine learning system may be trained using event data from users who have achieved some threshold number of achievements in a game. The machine learning system may then be used to classify other users based on whether the machine learning system predicts that those users will achieve that threshold number of achievements based on those user's to-date usage of the game, as reflected in their event data. A machine learning system may be implemented in any suitable manner, and may, for example, be part of the explorer server 110, and may both be trained on event data from the event logs 142 and classify users based on event data from the event logs 142.

The time series filter 580 may also allow for the selection of pre-set filter criteria, resulting in the selection of pre-set views of time series for the user interface 500. The pre-set views may be selected directly by a user of the explorer client 410, or may be selected by the based on a question entered into the time series filter 580 by a user, such as, for example, “What happens at the start of gameplay?”, “What happens before the user first spends money?”, and “What happens before the user quits using the application?”. The user interface 500 may also display certain questions which correspond to pre-set views, and the questions may be selected directly through any suitable input to the user interface 500. The pre-set views may highlight events or series of events that may be considered critical in the relationship between the user and the application, such as events that occur in the first few minutes of use of the application, events that occur before the user spends money, and events before the user gives a good or bad review to the application, events before the application crashes, and events that occur before the user quits the application without intent to return to it.

The filter criteria or pre-set views selected using the time series filter 580 may be affect the display of time series, such as the time series visualization 555, in the user interface 500. For example, for some filter criteria, the time key 570 may start at a time of 0, or an actual time, with visual representations arranged along the timeline for the time series with the visual representations for later events display to the right of earlier events. For some filter criteria, the last event in a time series, such as, for example, a churn event, may have a visual representation displayed at the beginning, or left, of a timeline, with visual representations for earlier events displayed to the right. This may allow for a number of time series to be visually aligned based on a common event. For some filter criteria, visual representations for a specific event in the time series, for example, the first spending event in a time series, may be displayed so that the visual representations for that event in all displayed time series align with each other.

Event display controls 581, 583, and 587 may allow for control of the events for which visual representations are displayed on the timelines of the displayed time series in the user interface 500. For example, a user may select any event type to cause the visual representations, or symbols, representing that event to be displayed or not displayed on the timelines of the time series displayed in the user interface 500. This may allow, for example, a user of the explorer client 410 to hide visual representations of events the user is not interested in, while showing visual representations of events the user is interested in.

Segment display control 590 may allow for control of the segments for which time series are displayed in the user interface 500. For example, a user may select a segment in the segment display control 590 to cause that segment to be displayed or not displayed in the user interface 500. This may allow, for example, a user to generate multiple segments using the time series filter 580, and to select which of the segments are displayed at a given time to allow for visual comparisons between the time series in the multiple segments.

Visualizations of time series, such as the time series visualization 555, may allow a user, for example, a developer, to visualize events that were logged as event data during the use of an application by a user. This may allow a developer to determine patterns of usage for an individual, anonymized, user, or among a number of anonymized users through visual inspection of time series such as the time series visualization 555. For example, a developer may able to detect a pattern of events or events that occur in time series immediately preceding a churn event, which may allow the developer to determine why users stop using their application. Displaying different segments may allow a developer to compare events that occur during usage of the application by different types of users. For example, a first segment may include time series from users that include a churn event occurring within 7 days of the users first use of the application, while a second segment may include time series from users that do not include a churn event occurring within 7 days of the users first use of the application. The visualization of time series, such as the time series visualization 555, may be displayed in the user interface 500, and the developer may visually inspect the arrangement of the symbols, such as the symbols 561, 562, 563, 564, 565, 566, 567, 568, and 569, to determine if any pattern of events indicates why users in the first segment churned and users in the second segment did not.

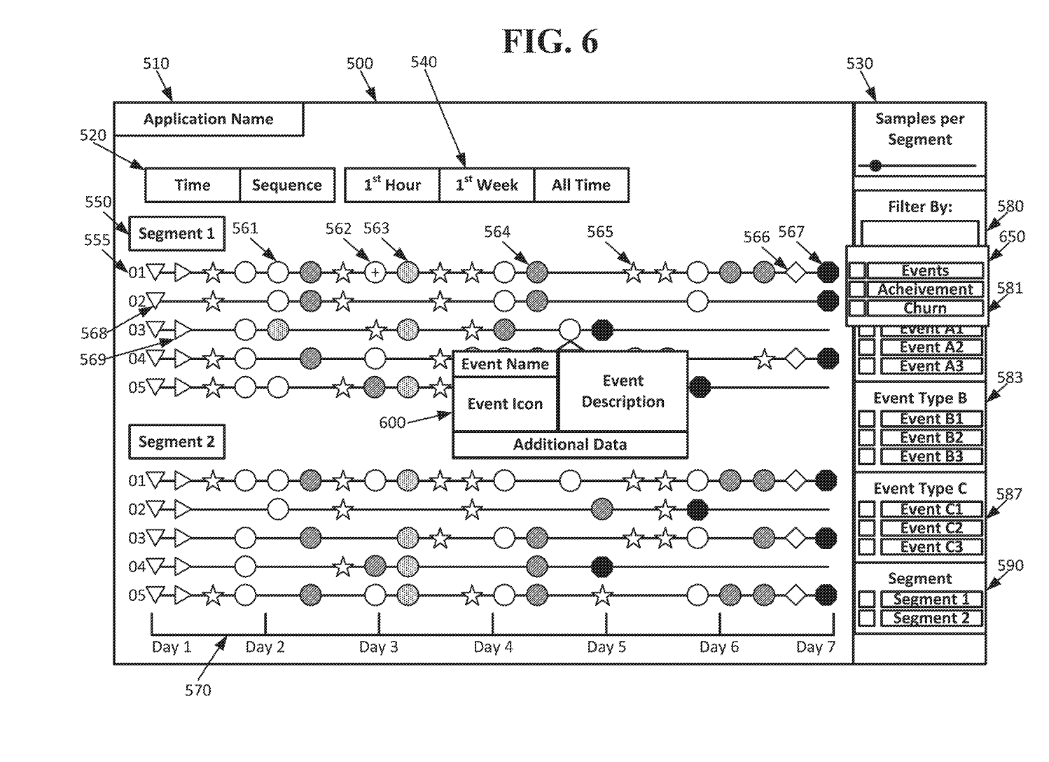

FIG. 6 shows an example user interface suitable for a time series explorer according to an implementation of the disclosed subject matter. An event pop-up 600 may appear in the user interface 500 when a visual representation of an event, such as, for example, any of the displayed symbols such as the symbol 561, are selected by the user. The user may select a visual representation on the user interface 500 in any suitable manner, for example, tapping or pressing and holding at the location of the visual representation on a touchscreen, clicking on or hovering over the visual representation with a cursor controlled by an input device such as a mouse or touchpad, or selecting the visual representation using a keyboard input. The event pop-up 600 that appears when a visual representation is selected may display any suitable information about the event associated with the visual representation, for example, as taken from the event data in the time series data sent to the explorer client 410. The information displayed may include, for example, a full description of the event, a time, day, and date for the event, and aggregate data related to the event. For example, if the event was the purchase of a specific item, the additional information for that event in the time series may include the date on which the user made the purchase, how much money the user spent, the quantity and identity of the item the user purchased, aggregate totals of how many of that item have been sold over the lifetime of the application and how much revenue that item has generated. If the user gained some achievement, the additional information displayed on selection of the representation of that event may include the name of the achievement, a graphic associated with the achievement, the data on which the achievement was obtained, and any other useful data related to achievements. The information displayed in the event pop-up 600 may be different for the same event depending on how the visual representation for that event is selected. For example, hovering over a visual representation may result in the event pop-up 600 including some basic information about the associated event, while clicking on the visual representation may result in the event pop-up 600 including a greater amount of information about the associated event.

Time series filter selector 650 may appear when the time series filter 580 is activated. The time series filter 580 may be activated in any suitable manner, such as, for example, through entry of text into the time series filter 580, or through clicking on the time series filter 580. The time series filter selector 650 may allow for the selection of the filter criteria that may be used to determine which visualizations of time series are displayed in the user interface 500.

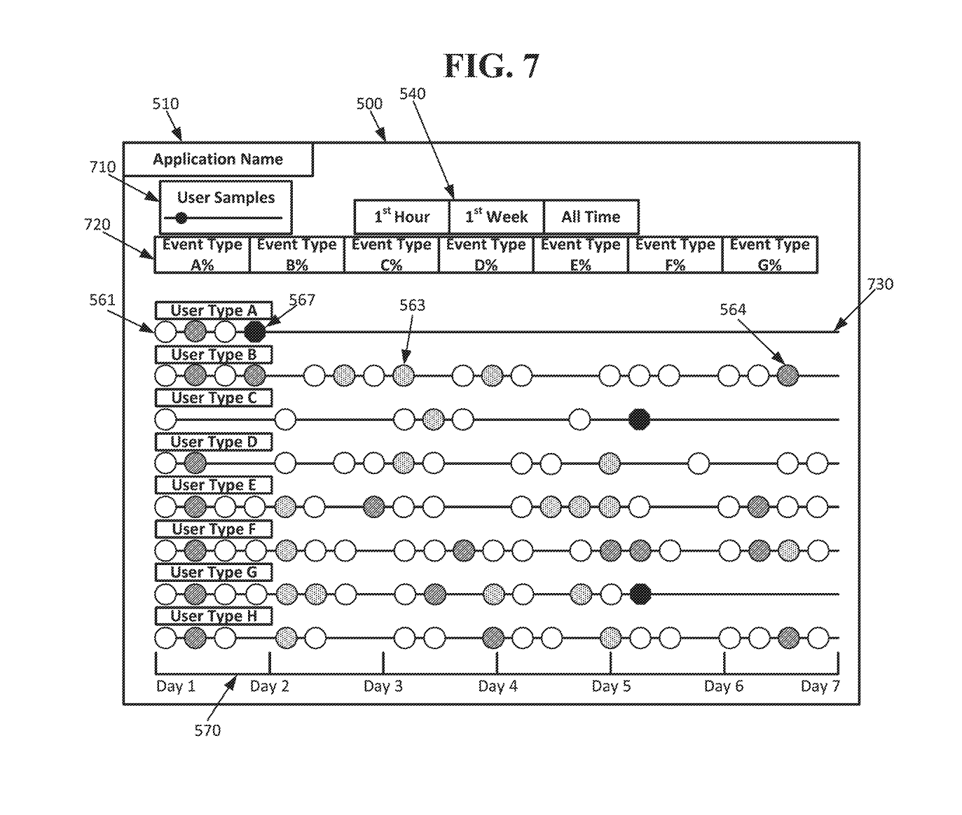

FIG. 7 shows an example user interface suitable for a time series explorer according to an implementation of the disclosed subject matter. The user interface 500 may display time series which may be representative of certain categories of users of the application indicated by the application name 510. A user samples controls 710 may be used to set the number category types for which time series are displayed in the user interface 500. An event percentages display 720 may display the percentage of time series that include each type of a certain event. For example, the event percentage display 720 may show the percentage of time series that include a churn event out of some group of time series, such as, for example, all time series available in the event logs 142, all time series used to determine representative time series for the category types displayed in the user interface 500, or any other suitable subset of time series. Representative time series, such as the representative time series visualization 720, may be displayed using visual representations of events arranged on a timeline. The representative time series for a category type may be determined in any suitable manner, such as, for example, through cluster analysis of the time series available in the event data of the event logs 142. For example, a cluster analysis may be used to determine the time series from the event logs 142 that represent a “quick churner” type, which may be a user of a game who churns quickly after initial use of the game. The cluster analysis may determine the group of time series that are at the center of the cluster of time series that represent the “quick churner” type, and may then take the middle time series from that group. The middle time series may be used as the representative time series for the “quick churner” category, and may be displayed on the user interface 500, for example, as the representative time series visualization 720. This may allow for the visual comparison of the most representative time series for a number of different category types, for example, allowing a comparison between the events logged for a representative “quick churner” and, for example, a representative “quick spender.” The category types used for cluster analysis may be any suitable category types, based on any suitable criteria. Different category types may be used for analyzing time series from different applications.

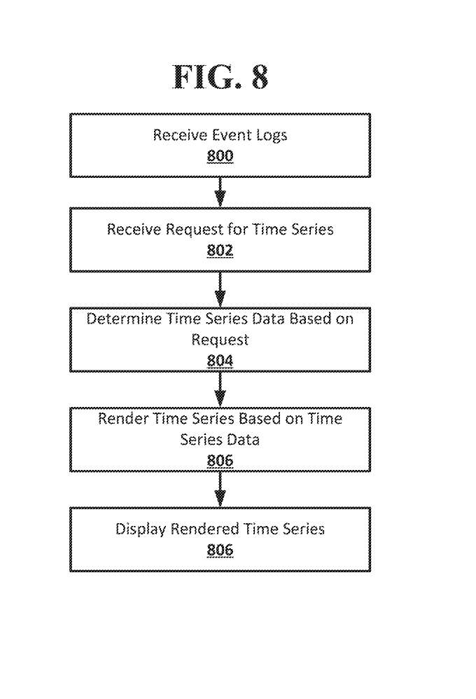

FIG. 8 shows an example of a process suitable for a time series explorer according to an implementation of the disclosed subject matter. At 800, event logs may be received. For example, the server 100 may receive event logs, such as the event log 242, from various computing devices, such as the user computing devices 200, 300, 310, and 320. The received event logs may include event data logged on the various user computing devices in conjunction with applications, such as the application 210, installed on those various user computing devices. The event logs may include event data logged based on the same application or different applications. The received event logs may be stored. For example, the event logs may be stored with the event logs 142 in the storage 140 of the server 100.

At 802, a request for time series may be received. For example, the explorer server 110 on the server 100 may receive a request for time series from the explorer client 410 on the developer computing device 400. The request for time series may include any suitable data or criteria that may be used to by the explorer server 110 to determine which event data from the event logs 142 form time series responsive to the request for time series. For example, the request may specify criteria regarding the application, such as the application 210, with which the time series may be associated, events which a time series may need to include or not include, time constraints on the occurrence of events within a time series, threshold amounts of activity indicated by events in the time series, such as, for example, a threshold amount of time spent playing a game, money spent in a game, points accrued in the game, achievements as indicated by achievement events, and any other suitable criteria. The criteria in the request for time series may be, for example, filter criteria set using the time series filter 580 in the user interface 500.

At 804, time series data may be determined based on the request. For example, the explorer server 110 may use the criteria in the request for time series to determine which time series in the event logs 142 are responsive to the request. The explorer server 110 may, for example, determine which time series are from an application or application specified in the request for time series. The explorer server 110 may analyze the event data in the event logs 142 to determine time series with events that match criteria in the request for time series. The event data from time series that are determined to be responsive to the request for time series may be the time series data. The time series data may include event data for multiple time series

At 806, time series may be rendered based on time series data. For example, visual representation of the events with event data in the time series data may be rendered on a timeline for each time series. For example, the time series visualization 555 may be rendered from event data for a single time series in the time series data. The time series visualization may be rendered using any suitable visual representations of the events, including graphics, icons, and symbols such as the symbols 561, 562, 563, 564, 565, 5666, 567, 568, and 569. The rendering may be performed by the explorer server 110, which may then transmit renderings to the explorer client 410 for display, or may be performed by the explorer client 410, for example, based on time series data received from the explorer server 110. The number of time series that may be rendered visually from the time series data may depend, for example, on the setting of the samples control 530. The rendering may also be based on the current zoom level of the user interface 500 and the current setting of the data window control 540. For example, some time series may have event data with overlapping visual representations due to the user interface 500 being zoomed out to a degree that the resolution of the display on which the renderings of the time series will be displayed isn't high enough for all of the visual representations of events to be depicted discretely on the display.

At 808, the time series may be displayed. For example, explorer client 410 may receive renderings of the visualizations of time series from the explorer server 110 and display the renderings in the user interface 500 on a display connected to the developer computing device 400. The visualizations of time series may also be rendered directly to the user interface 500 on a display connected to the developer computing device 500 by the explorer client 110, which may have received the time series data from the explorer server 110.

Embodiments of the presently disclosed subject matter may be implemented in and used with a variety of component and network architectures. FIG. 9 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 10.

Many other devices or components (not shown) may be connected in a similar manner, such as document scanners, digital cameras, auxiliary, supplemental, or backup systems, or the like. Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 10 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various.

1. A computer-implemented method performed by a data processing apparatus, the method comprising:
receiving a request for time series comprising at least one filter criteria;
determining at least one time series that is responsive to the request for time series by comparing event data for the time series stored in an event log to the at least one filter criteria, the event data comprising indications of at least one event that occurred in an application running on a computing device;
rendering a visual representation of the at least one time series wherein the visual representation of the at least one time series comprises at least one visual representation of an event indicated by the event data for the time series; and
transmitting the visual representation of the at least one time series to be displayed on a display.

2. The computer-implemented method of claim 1, further comprising:
receiving the event log from a user computing device; and
storing the event log.

3. The computer-implemented method of claim 1, wherein rendering the visual representation of the at least one time series further comprises:
rendering a visual representation of the event on a timeline;
rendering a visual representation of a second event indicated by the event data for the at least one time series on the timeline; and
rendering a visual representation of a third event indicated by the event data for the at least one time series on the timeline.

4. The computer-implemented method of claim 3, wherein the visual representation of the event, the visual representation of the second event, and the visual representation of the third event are rendered on the timeline to appear in chronological order.

5. The computer-implemented method of claim 1, further comprising:
rendering a visual representation of a second time series wherein the visual representation of the second time series comprises at least one visual representation of an event indicated by event data for the second time series; and
transmitting the visual representation of the second time series to be displayed on a display with the visual representation of the at least one time series.

6. The computer-implemented method of claim 1, further comprising:
receiving an indication of a selection of the visual representation of the event through input to a user interface displayed on the display with the visual representation of the at least one time series;
rendering a box comprising additional information associated with the event based on the event data from the event log; and
transmitting the box comprising the additional information to be displayed on the display.

7. The computer-implemented method of claim 1, further comprising:
performing cluster analysis on a plurality of time series stored in one or more event logs, wherein the cluster analysis groups the time series into two or more clusters, each cluster corresponding to a category;
determining, for a first cluster of the two more clusters of time series, a group of time series in the middle of the first cluster; and
determining a time series that is a middle member of the group of time series in the middle of the first cluster.

8. The computer-implemented method of claim 7, further comprising:
rendering a visual representation of the time series that is the middle member of the group of time series in the middle of the first cluster; and
transmitting the visual representation of the time series that is the middle member of the group of time series in the middle of the first cluster to be displayed as a representative time series for a category associated with the first cluster.

9. A computer-implemented system comprising:
a storage comprising one or more event logs;
an explorer server configured to receive a request for time series comprising at least one filter criteria, determine at least one time series that is responsive to the request for time series by comparing event data for the time series stored in the one or more event logs to the at least one filter criteria, the event data comprising indications of at least one event that occurred in an application running on a computing device, render a visual representation of the at least one time series wherein the visual representation of the at least one time series comprises at least one visual representation of an event indicated by the event data for the time series, and transmit the visual representation of the at least one time series to be displayed on a display.

10. The computer-implemented system of claim 9, wherein the explorer server is further configured to receive at least one of the one or more event logs from a user computing device, and store the event log.

11. The computer-implemented system of claim 9, wherein the explorer server is further configured to render the visual representation of the at least one time series by rendering a visual representation of the event on a timeline, rendering a visual representation of a second event indicated by the event data for the at least one time series on the timeline, rendering a visual representation of a third event indicated by the event data for the at least one time series on the timeline.

12. The computer-implemented system of claim 11, wherein the visual representation of the event, the visual representation of the second event, and the visual representation of the third event are rendered on the timeline to appear in chronological order.

13. The computer-implemented system of claim 9, wherein the explorer server is further configured to render a visual representation of a second time series wherein the visual representation of the second time series comprises at least one visual representation of an event indicated by event data for the second time series, and transmit the visual representation of the second time series to be displayed on a display with the visual representation of the at least one time series.

14. The computer-implemented system of claim 9, wherein the explorer server is further configured to receive an indication of a selection of the visual representation of the event through input to a user interface displayed on the display with the visual representation of the at least one time series, render a box comprising additional information associated with the event based on the event data from one of the one or more event logs, and transmit the box comprising the additional information to be displayed on the display.

15. The computer-implemented method of claim 9, wherein the explorer server is further configured to perform cluster analysis on a plurality of time series stored in the one or more event logs, wherein the cluster analysis groups the time series into two or more clusters, each cluster corresponding to a category, determine, for a first cluster of the two more clusters of time series, a group of time series in the middle of the first cluster, and determine a time series that is a middle member of the group of time series in the middle of the first cluster.

16. The computer-implemented method of claim 15, wherein the explorer server is further configured to render a visual representation of the time series that is the middle member of the group of time series in the middle of the first cluster, and transmit the visual representation of the time series that is the middle member of the group of time series in the middle of the first cluster to be displayed as a representative time series for a category associated with the first cluster.

17. The computer-implemented method of claim 9, wherein the wherein the explorer server is further configured to transmit the visual representation of the at least one time series to an explorer client running on a computing device separate from a computing device running the explorer server.

18. A system comprising: one or more computers and one or more storage devices storing instructions which are operable, when executed by the one or more computers, to cause the one or more computers to perform operations comprising:
receiving a request for time series comprising at least one filter criteria;
determining at least one time series that is responsive to the request for time series by comparing event data for the time series stored in an event log to the at least one filter criteria, the event data comprising indications of at least one event that occurred in an application running on a computing device;
rendering a visual representation of the at least one time series wherein the visual representation of the at least one time series comprises at least one visual representation of an event indicated by the event data for the time series; and
transmitting the visual representation of the at least one time series to be displayed on a display.

19. The system of claim 26, wherein the instructions further cause the one more computers to perform operations further comprising:
rendering a visual representation of the event on a timeline;
rendering a visual representation of a second event indicated by the event data for the at least one time series on the timeline; and
rendering a visual representation of a third event indicated by the event data for the at least one time series on the timeline.

20. The system of claim 26, wherein the instructions further cause the one more computers to perform operations further comprising:
rendering a visual representation of a second time series wherein the visual representation of the second time series comprises at least one visual representation of an event indicated by event data for the second time series; and
transmitting the visual representation of the second time series to be displayed on a display with the visual representation of the at least one time series.
